(19) United States
(12) Patent Application Publication
(10) Pub. No.: US 2008/0276734 A1
(43) Pub. Date: Nov. 13, 2008

(54) Torque limiter for engine starter

(76) Inventor: David A. Fulton, Anderson, IN (US)

Correspondence Address: CANTOR COLBURN, LLP, 20 Church Street, 22nd Floor, Hartford, CT, 06103, US

(21) Appl. No.: 11/801,204

(22) Filed: May 9, 2007

(51) Int. Cl. F02N 15/04; F16H 57/08

(52) U.S. Cl. 74/8; 475/331

(57) ABSTRACT

Disclosed is a starter motor including a drive assembly disposed at least partially within the housing. The drive assembly includes a gear train disposed in the housing, with the gear train in operable communication with a first end of an armature shaft. A pinion gear is in operable communication with a second end of the output shaft. A spacer is disposed between the gear train and the housing. The spacer is disposed and configured to hold the gear train fixed relative to the housing but allow the gear train to rotate relative to the housing when a selected slippage torque is applied to the gear train.

### BACKGROUND OF THE INVENTION

The present invention relates generally to a starter motor for starting an internal combustion engine. More specifically, this invention relates to a torque-limiting feature for a starter motor.

Most automotive and heavy-duty vehicles use engine starter motors with internal gear trains. The internal gear trains are typically planetary configurations. Planetary gearing is a gear system that consists of one or more outer gears, or planet gears, rotating about a central, or sun gear. Typically, the planet gears are mounted on a movable arm or carrier which itself may rotate relative to the sun gear. The planetary gear system includes an outer ring gear that meshes with the planet gears. In these gear trains, the ring gear is typically held fixed in the starter motor housing. The gear train is connected to an armature shaft of the starter motor which includes a pinion gear. The pinion gear meshes with an engine flywheel, and the rotation of the pinion gear when the starter motor is operating turns the flywheel which puts the engine cylinders into motion.

During operation of the starter motor, the starter motor is loaded with a pulsating torque, due to compression strokes in engine cylinders. The pulsating torque is typically less than the stall torque, a torque value which causes the starter RPM to go to zero. In some situations, however, the starter motor may encounter torques that are much higher than the stall torque value. These situations may include engine backfire, hydraulic lock-up, or if the starter motor is re-engaged into an engine that is in operation. For example, hydraulic lock-up results in torque that is about 5× to 6× of the stall torque. The high torques are primarily caused by kinetic energy stored in the armature, which is then converted to strain energy upon rapid deceleration of the armature. Vehicle manufacturers require that the starter motor shall not fail or cause failure of other engine components when these high-torque situations occur. To meet this requirement, starter motor components must be designed and manufactured to withstand the torques in excess of the stall torque. This often results in starter motor components being larger, heavier, or made from more robust and expensive materials than if the components were only required to withstand the torques encountered during normal operation.

A solution that will limit the torque internal to the starter motor would be well received in the art so the starter motor components can be smaller or made from less expensive, less robust materials.

### SUMMARY OF THE INVENTION

An improved starter motor includes a drive assembly disposed at least partially within a housing. The drive assembly includes a gear train disposed in the housing, with the gear train in operable communication with a first end of an armature shaft. A pinion gear is in operable communication with an output shaft.

A spacer is disposed between the ring gear and the housing. The spacer is disposed and configured to hold the ring gear fixed relative to the housing but allow the gear train to rotate relative to the housing when a selected slippage torque is applied to the gear train.

### DESCRIPTION OF THE DRAWINGS

The above, as well as other advantages of the present invention, will become readily apparent to those skilled in the art from the following detailed description when considered in the light of the accompanying drawings in which:

FIG. 1 is a perspective view of an example of a starter motor.

FIG. 2 is a cross-sectional view of a drive assembly of the starter motor of FIG. 1.

### DETAILED DESCRIPTION OF THE INVENTION

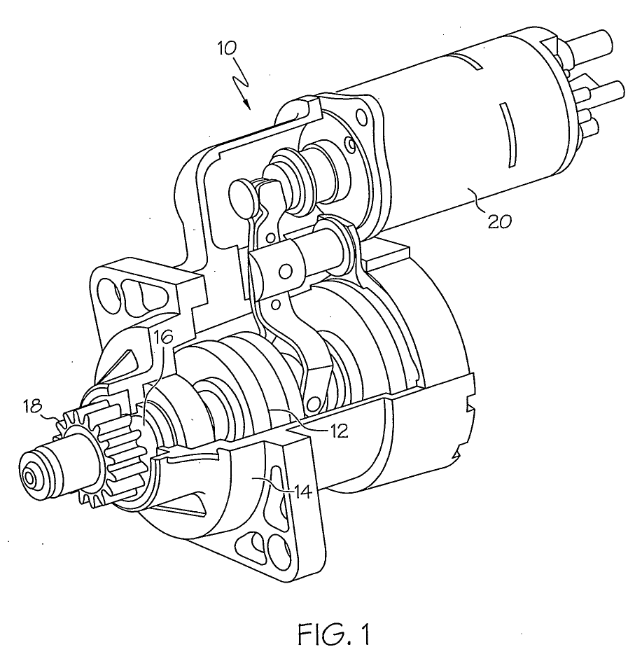

Shown in FIG. 1 is a starter motor 10. The starter motor 10 includes a drive assembly 12 at least partially disposed in a drive housing 14. The drive assembly 12 includes an output shaft 16, which drives a pinion gear 18. The starter motor 10 further comprises a solenoid 20, which when energized, articulates the output shaft 16 in an axial direction to a position where pinion gear 18 will mesh with a flywheel of an engine.

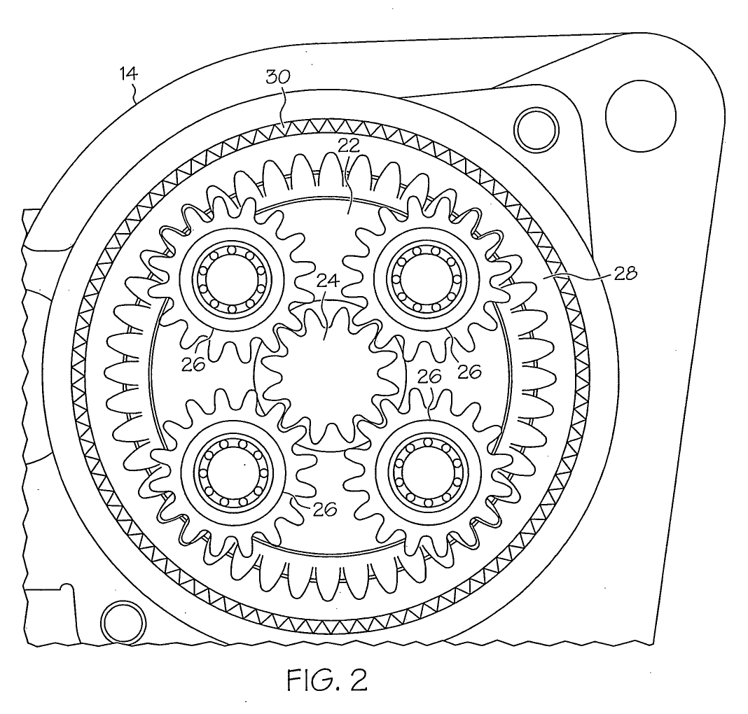

As shown in FIG. 2, the drive assembly 12 includes an internal gear train 22 disposed in the housing 14. In this embodiment, the gear train 22 is a planetary configuration, however, it is to be appreciated that other gear configurations may be employed within the scope of this invention. The gear train 22 comprises a sun gear 24 which is attached to the output shaft 16. One or more planet gears 26 are disposed in the housing 14 and are configured and positioned to mesh with the sun gear 24. A ring gear 28 is positioned to surround and mesh with the one or more planet gears 26. A spacer 30 is disposed radially between the ring gear 28 and the housing 14. In one embodiment, the spacer is press fit into position between the ring gear 28 and the housing 14 and is fixed to the ring gear 28. It is to be appreciated, however, that the spacer may alternatively be fixed to the housing 14. Alternatively, the spacer 30 may be disposed between the ring gear 28 and the housing 14 while being fixed to neither the ring gear 28 nor the housing 14. The spacer 30 in one embodiment is configured as a tolerance ring. The spacer 30 in this embodiment is made from spring steel and has a corrugated cross-section, with the corrugations disposed circumferentially around the spacer. Other suitable materials and cross-sections, however, are contemplated within the scope of this invention. The spacer 30 is configured such that friction between the spacer 30, the housing 14, and the ring gear 28 is sufficient to prevent the ring gear 28 from rotating relative to the housing 14 unless a torque transmitted to the ring gear 28 through the planet gears 26 equals or exceeds a predetermined slippage torque. In the event the torque exceeds the slippage torque, the ring gear 28, together with the spacer 30, rotates on the planet gears 26 until such time that the torque returns to a level below the slippage torque.

An event torque from an event such as a backfire or a hydraulic lockup, for example, which in some instances can be about 6× the stall torque of the starter motor 10, is transferred to the starter motor 10 through the engine flywheel (not shown). The event torque is transferred from the flywheel through the pinion gear 18, through the output shaft 16, and into the plurality of planet gears 26, specifically into a planet carrier pin (not shown) disposed in each planet gear 26. The event torque is then reacted to in the sun gear 24 and the ring gear 28. If the event torque is greater than the slippage torque, the ring gear 28 rotates relative to the housing 14. Allowing the ring gear 28 to rotate in the case of such event torques prevents the event torques from being absorbed by the starter 10 components such as, for example, output shaft 16 and gear train 22 and thus prevents damage to them. Allowing the ring gear 28 to rotate further allows the starter motor 10 components to be made smaller, lighter, or from less robust or less expensive materials, and additionally reduces the risk of damage to the engine flywheel, or other engine components.

The slippage torque in this embodiment is set at a value of 2× the stall torque of the starter motor 10. This limit is high enough to prevent rotation of the ring gear 28 during normal operation, but is still much lower than the torque of 6× the stall torque that is possible during a hydraulic lock-up event. The setting of stall torque equal to 2× the stall torque of the starter motor 10 in this embodiment is and example only. Other values of slippage torque such as, for example, 3× or 5× the stall torque may be set depending on the application by changes in the designs of the housing 14, spacer 30, and ring gear 28 that increase or decrease the amount of friction between the components.

Rotation of the ring gear 28 can cause wear to the ring gear 28 and/or to the spacer 30. The wear can, in turn, reduce a compression of the spacer 30 resulting in a reduction of the slippage torque over time. Alternatively, if surfaces of the ring gear 28 or the spacer 30 are damaged by galling, the slippage torque could increase over time. To prevent change in the slippage torque over time, some embodiments include a lubricant coating of, for example, grease which is applied during installation of the spacer 30 on the spacer 30 or the ring gear 28.

Another consideration in ensuring that the slippage torque remains substantially constant is to minimize the effects of temperature on the slippage torque. To accomplish this, it is advantageous to use materials for the ring gear 28 and the housing 14 with similar coefficients of thermal expansion to maintain a substantially constant compression on the spacer 30 as the temperature of the starter motor 10 changes. For example, the housing 14 and the ring gear 28 could both be made from aluminum.

While embodiments of the invention have been described above, it will be understood that those skilled in the art, both now and in the future, may make various improvements and enhancements which fall within the scope of the claims which follow. These claims should be construed to maintain the proper protection for the invention first described.

What is claimed is:

1. A starter motor comprising:
a housing; and
a drive assembly disposed at least partially within the housing, the drive assembly including:
a gear train disposed in the housing in operable communication with a first end of an output shaft;
a pinion gear in operable communication with a second end of the output shaft; and
a spacer disposed between the gear train and the housing, the spacer holding the gear train fixed relative to the housing but allowing the gear train to rotate relative to the housing when a selected slippage torque is applied to the gear train.

2. The starter motor of claim 1 wherein the gear train is a planetary gear configuration.

3. The starter motor of claim 2 wherein the planetary gear configuration comprises a sun gear, a one or more planet gears, and a ring gear, the planet gears in operable communication with the output shaft.

4. The starter motor of claim 1 wherein the spacer is substantially a ring.

5. The starter motor of claim 3 wherein the spacer is press fit between the ring gear and the housing.

6. The starter motor of claim 3 wherein the spacer is installed such that the spacer is fixed to the ring gear.

7. The starter motor of claim 1 wherein the spacer has a corrugated cross section.

8. The starter motor of claim 1 wherein the slippage torque is two times a stall torque of the starter motor.

9. The starter motor of claim 1 wherein a lubricant is interspersed between the spacer and the gear train.

10. The starter motor of claim 1 wherein the gear train and the housing are formed from materials having substantially the same coefficient of thermal expansion.

11. The starter motor of claim 10 wherein the gear train and the housing are both formed from aluminum.

12. A starter motor comprising:
a housing; and
a drive assembly disposed at least partially within the housing, the drive assembly including:
a gear train having a planetary configuration disposed in the housing in operable communication with a first end of an output shaft;
a pinion gear in operable communication with a second end of the output shaft; and
a spacer disposed between the gear train and the housing, the spacer holding the gear train fixed relative to the housing but allowing the gear train to rotate relative to the housing when a selected slippage torque is applied to the gear train.

13. The starter motor of claim 12 wherein the planetary gear configuration comprises a sun gear, one or more planet gears, and a ring gear, the planet gears in operable communication with the output shaft.

14. The starter motor of claim 13 wherein the spacer is press fit between the ring gear and the housing.

15. The starter motor of claim 13 wherein the spacer is installed such that the spacer is fixed to the ring gear.

16. The starter motor of claim 12 wherein the spacer is substantially a ring.

17. The starter motor of claim 12 wherein the spacer ring has a corrugated cross section.

18. The starter motor of claim 12 wherein the slippage torque is two times a stall torque of the starter motor.

19. The starter motor of claim 12 wherein a lubricant is interspersed between the spacer and the gear train.

20. The starter motor of claim 12 wherein the gear train and the housing are formed from materials having substantially the same coefficient of thermal expansion.
